(19) United States
(12) Patent Application Publication
(10) Pub. No.: US 2024/0427872 A1
(43) Pub. Date: Dec. 26, 2024

(54) METHODS AND SYSTEMS FOR ENABLING CUSTOM FEATURES USING PUBLIC KEY INFRASTRUCTURE IN MEMORY DEVICES

(71) Applicant: SK Hynix NAND Product Solutions Corp. (dba Solidigm), Rancho Cordova, CA (US)

(72) Inventors: Jordan HOWES, Folsom, CA (US); Gamil CAIN, El Dorado Hills, CA (US)

(21) Appl. No.: 18/237,345

(22) Filed: Aug. 23, 2023

Related U.S. Application Data
(60) Provisional application No. 63/522,097, filed on Jun. 20, 2023.

(51) Int. Cl. G06F 21/44; H04L 9/32

(52) U.S. Cl. CPC G06F 21/44; H04L 9/3263

(57) ABSTRACT

This application is directed to managing custom memory functions in a memory device coupled to a host device in an electronic system. The memory device obtains an information item (e.g., program, data, metadata) used to implement a custom memory function. The memory device receives a host signature and a public key from the host device and authenticates the host signature using the public key. In accordance with an authentication of at least the host signature, the memory device executes the custom memory function based on the information item. In some embodiments, the host device selects a set of memory devices based on a first-come-first-serve order, and the custom memory function is executed at each of the set of memory devices in accordance with an authentication of at least a respective host signature issued by the host device.

### RELATED APPLICATIONS

This application claims priority to U.S. Provisional Patent Application No. 63/522,097, filed Jun. 20, 2023, entitled “This Method Leverages Asymmetric Cryptography To Enable Custom And Debug Features In SSDs, And Embedded Devices In General,” which is hereby incorporated by reference in its entirety.

### TECHNICAL FIELD

This application relates generally to memory management including, but not limited to, methods, systems, and non-transitory computer-readable media for secure management of memory functions in a memory system.

### BACKGROUND

Memory is applied in a computer system to store instructions and data. Particularly, the computer system relies on non-volatile memory to keep instructions and data stored thereon if the computer system is decoupled from a power source. Examples of the secondary memory include, but are not limited to, hard disk drives (HDDs) and solid-state drives (SSDs). Different SSDs can be configured to implement different memory functions under the control of its host device. An SSD manufacturer sometimes releases program codes of a custom memory function specifically to a group of target customers (who buy SSDs and install them on their computer systems). Only the computer system receives the program codes directly from the SSD manufacturer can execute the custom memory function. Overhead of managing such a targeted custom release is large. There is a high probability of sending the program codes to an unintended customer, while few solutions are available to restrict such a custom release to only the targeted customers or a subset of devices within the targeted customers' deployment pool. For security concerns, many customers (e.g., who require general availability (GA) releases) are not willing to accept a custom release, and most probably will reject it directly. Alternatively, an SSD manufacturer may release program codes of a custom memory function broadly among its customers. A group of target customers is identified on a list of serial numbers or identifiers. Only the customers as identified on the list are permitted to execute the custom memory function. The list of serial numbers or identifiers has to be distributed broadly in a secure manner, which makes this solution unfit for broad deployment of the custom memory function. Such a broad non-targeted release can involve a cumbersome process and take an extended turnaround time, particularly because the list of serial numbers or identifiers is included in every release. It would be beneficial to develop a mechanism for deploying memory functions efficiently and securely in memory systems (e.g., SSDs).

### SUMMARY

Various embodiments of this application are directed to methods, systems, devices, and non-transitory computer-readable media for secure management of custom memory functions on a memory device coupled to a host device in an electronic system (e.g. a computer system). A public key infrastructure (PKI) is created in the electronic system, allowing asymmetric cryptography to be applied to enable custom memory functions (e.g., certain debug features, retrieval of custom statistics) in the memory device of the electronic system. Particularly, in some situations, the electronic system deploys a custom memory function to a group of target host devices and their associated memory devices. Examples of the custom memory function include, but are not limited to, a debugging or experimental function that helps debug a specific memory issue and a specific memory feature to be enabled on mass market memory products (e.g., an SSD manufactured in a selected batch) owned by target customers. The use of asymmetric cryptography enables a secure method for enabling custom memory features and capabilities. Underlying cryptographic capabilities are implemented on an electronic system having memory devices to manage secure deployment of custom memory functions on the memory device.

More specifically, in one aspect, a method is implemented for secure management of a custom memory function on a memory device (e.g., including one or more SSDs) coupled to a host device in an electronic system. The method includes obtaining an information item used to implement a custom memory function, receiving a host signature and a public key from the host device, authenticating the host signature using the public key, and in accordance with an authentication of at least the host signature, executing the custom memory function based on the information item. Further, in some embodiments, the information item is associated with the public key, and applied to implement the custom memory function in accordance with a verification of the public key.

In some embodiments, the memory device includes a first memory device. The host device is coupled to a plurality of memory devices, and a subset of the plurality of memory devices includes the first memory device. The custom memory function is executed at each of the subset of memory devices in accordance with an authentication of at least a respective host signature issued by the host device. The method further includes selecting, by the host device, the subset of memory devices based on a first-come-first-serve order by obtaining a host identity certificate from each of the subset of memory devices.

In some embodiments, the memory device includes a first memory device. The method further includes receiving, from the host device, a certificate signing request for a host identity certificate for each of a set of memory devices coupled to the host device and including the first memory device: The method further includes for each of the set of memory devices, receiving a second host signature with the certificate signing request and in accordance with a verification of the second host signature, generating the host identity certificate and providing the host identity certificate to the host device. The information item is applied at each of the set of memory devices, further in accordance with a verification of the host identity certificate provided by the respective memory device to the host device.

Some implementations of this application include an electronic system that includes one or more processors and memory having instructions stored thereon, which when executed by the one or more processors cause the processors to perform any of the above methods on a memory system (e.g., SSD).

Some implementations include a non-transitory computer readable storage medium storing one or more programs. The one or more programs include instructions, which when executed by one or more processors cause the processors to implement any of the above methods on a memory system (e.g., SSD).

In some embodiments, a host device owned by a customer generates a pair of private key and public key and submits the public key to a server associated with a device vendor via a secure communication link. The server incorporates the public key into a firmware release containing a customer memory function. The firmware release is based on previously released production code, and includes the customer public key and data (e.g., program code, user data) associated with a custom memory function requested by the customer. In some embodiments, the public key is optionally built into the firmware, which exposes a provisioning interface that allows provisioning of the public key by the customer after downloading the firmware release. Alternatively, in some embodiments, the firmware release is production code and implemented onto a memory device associated with the host device based on a challenge response protocol (implemented using vendor unique (UV) commands defined by a storage device vendor). The memory device receives the firmware release, and is required to complete the challenge response protocol before the custom memory function can be implemented on the memory device. The challenge response protocol includes a challenge signed by the host device. The challenge is previously submitted by the host device to the server, and downloaded to the memory device associated with the host device. If the memory device (specifically, a memory drive or controller) determines that the challenge was successful, then the custom memory function is executed on the memory device. Conversely, if the memory device determines that the challenge is erroneous, the memory device continues to skip the custom memory function and execute existing memory functions. Given that the public key is embedded into the firmware, no one other than the memory device associated with the host device of the target customer is permitted to execute the custom memory function.

In some embodiments, the access to the custom memory function is cryptographically limited to one or more targeted customers. The vendor has assurance that other customers will not be permitted to execute the custom memory function. In some embodiments, the number of memory devices that can execute the custom memory function is unlimited, particularly when the host device fully owns a right to enable or disable the custom memory function. Even if the server associated with the vendor accidentally exposes the custom memory function to unintended users who do not know the public key provided by the targeted customers, the memory devices of the unintended users are prohibited from executing the custom memory function. The host device has flexibility to either simplify deployment of the custom functionality by using the same public/private key pair across the entire fleet or segment the fleet by creating multiple key pairs for different fleet segments. By these means, a server associated with a vendor can deploy custom memory functions to target host devices and associated memory devices (e.g., SSDs associated with individual or data center host devices) securely without non-disclosure agreements.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic system in accordance with some embodiments.

FIG. 2 is a block diagram of a memory system of an example electronic

system having one or more memory access queues, in accordance with some embodiments.

FIG. 3 is a flow diagram of an example secure memory function deployment process implemented among a server, a host device, and a memory device, in accordance with some embodiments.

FIGS. 4A-4B are a flow diagram of another secure memory function deployment process 400 implemented among a server, a host device, and one or more memory devices, in accordance with some embodiments.

FIG. 5 is a block diagram of an electronic system for deploying a custom memory function to a set of memory devices associated with a host device based on a first-come-first-serve order, in accordance with some embodiments.

FIG. 6 a flow diagram of an example method for executing a custom memory function securely in an electronic system, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with data storage capabilities.

This application is directed to secure management of custom memory functions on a memory device coupled to a host device in an electronic system (e.g. a computer system). A PKI is created in the electronic system, allowing asymmetric cryptography to be applied to enable custom memory functions (e.g., certain debug features) in the memory device of the electronic system. Particularly, in some situations, the electronic system deploys a custom memory function to a set of target host devices and their associated memory devices. Examples of the custom memory function include, but are not limited to, a debugging or experimental function that helps debug a specific memory issue and a specific memory feature to be enabled on mass market memory products (e.g., an SSD manufactured in a selected batch) owned by target customers. The use of asymmetric cryptography enables a secure method for enabling custom memory features and capabilities. Specifically, the memory device obtains an information item used to implement a custom memory function, and receives a host signature and a public key from the host device. The host signature is authenticated using the public key, and in accordance with an authentication of at least the host signature, the memory device executes the custom memory function based on the information item.

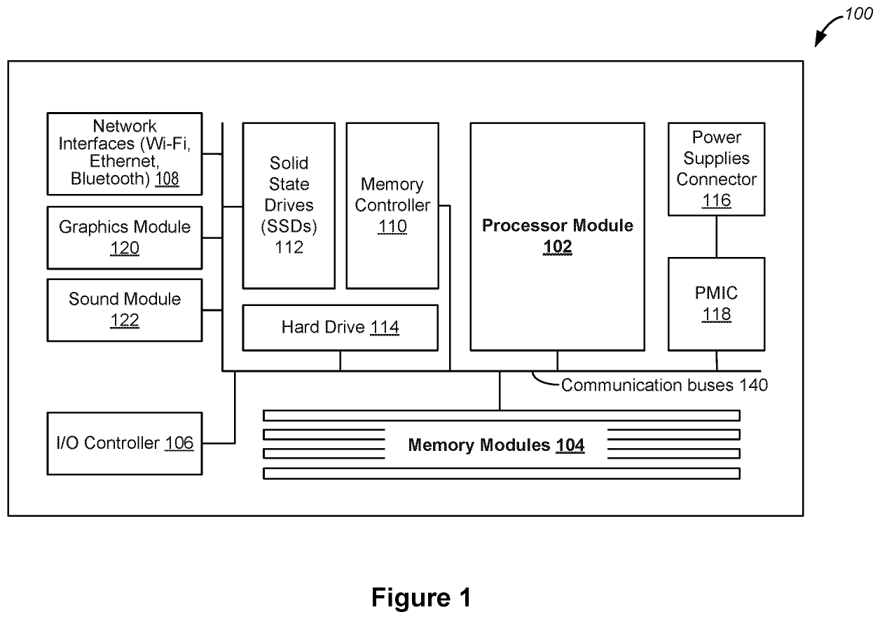

FIG. 1 is a block diagram of an example system module 100 in a typical electronic system in accordance with some embodiments. The system module 100 in this electronic device includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a track-pad) via a universal serial bus interface. In some embodiments, the network interfaces 108 includes one or more interfaces for Wi-Fi, Ethernet and Bluetooth networks, each allowing the electronic device to exchange data with an external source, e.g., a server or another electronic device. In some embodiments, the communication buses 140 include circuitry (sometimes called a chipset) that interconnects and controls communications among various system components included in system module 100.

In some embodiments, the memory modules 104 include high-speed random-access memory, such as DRAM, static random-access memory (SRAM), double data rate (DDR) dynamic random-access memory (RAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSDs 112, a hard disk drive (HDD) 114, power management integrated circuit (PMIC) 118, a graphics module 120, and a sound module 122. The memory controller 110 is configured to control communication between the processor module 102 and memory components, including the memory modules 104, in the electronic device. The SSDs 112 are configured to apply integrated circuit assemblies to store data in the electronic device, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic device. The graphics module 120 is configured to generate a feed of output images to one or more display devices according to their desirable image/video formats. The sound module 122 is configured to facilitate the input and output of audio signals to and from the electronic device under control of computer programs.

It is noted that communication buses 140 also interconnect and control communications among various system components including components 110-122.

Further, one skilled in the art knows that other non-transitory computer readable storage media can be used, as new data storage technologies are developed for storing information in the non-transitory computer readable storage media in the memory modules 104 and in SSDs 112. These new non-transitory computer readable storage media include, but are not limited to, those manufactured from biological materials, nanowires, carbon nanotubes and individual molecules, even though the respective data storage technologies are currently under development and yet to be commercialized.

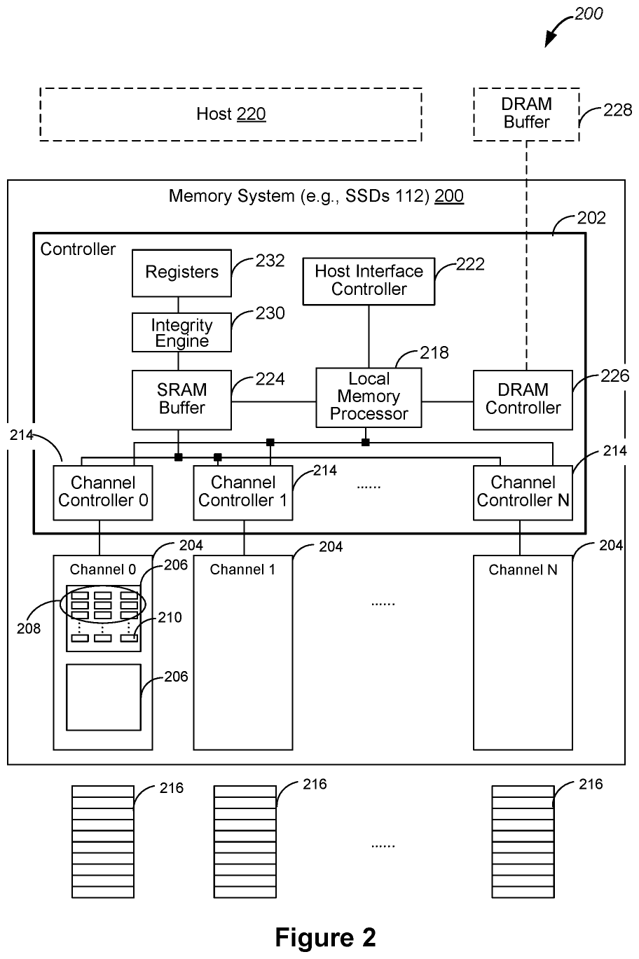

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 further includes a controller 202 and a plurality of memory channels 204. Each memory channel 204 includes a plurality of memory cells. The controller 202 is configured to execute firmware level software to bridge the plurality of memory channels 204 to the host device 220). In some embodiments, a set of memory channels 204 forms a memory device (e.g., a SSD), and the memory system 200 includes one or more memory devices.

Each memory channel 204 includes on one or more memory packages 206 (e.g., two memory dies). In an example, each memory package 206 corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory system 200 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory system 200 stores information of an ordered list of superblocks in a cache of the memory system 200. In some embodiments, the cache is managed by a host driver of the host device 220, and called a host managed cache (HMC).

In some embodiments, the memory system 200 includes a single-level cell (SLC) NAND flash memory chip, and each memory cell stores a single data bit. In some embodiments, the memory system 200 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 configured to control internal and external requests to access memory cells in the respective memory channel 204. In some embodiments, each memory package 206 (e.g., each memory die) corresponds to a respective queue 216 of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory system 200 corresponds to a single queue 216 of memory access requests. Each memory access request is optionally received internally from the memory system 200 to manage the respective memory channel 204 or externally from the host device 220 to write or read data stored in the respective channel 204. Specifically, each memory access request includes one of: a system write request that is received from the memory system 200 to write to the respective memory channel 204, a system read request that is received from the memory system 200 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller to implement internal memory management functions including, but are not limited to, garbage collection, wear levelling, read disturb mitigation, memory snapshot capturing, memory mirroring, caching. and memory sparing.

In some embodiments, in addition to the channel controllers 214, the controller 202 further includes a local memory processor 218, a host interface controller 222. an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228 that is in memory system 200. Alternatively, in some embodiments, the local memory processor 218 stores data to be written into, or read from, each memory block in the plurality of memory channels 204 in a DRAM buffer 228 that is main memory used by the processor module 102 (FIG. 1). The local memory processor 218 of the controller 202 accesses the DRAM buffer 228 via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory system 200 includes an integrity engine 230 (e.g., an LDPC engine) and registers 232 including a plurality of registers or SRAM cells or flip-flops and coupled to the integrity engine 230. The integrity engine 230 is coupled to the memory channels 204 via the channel controllers 214 and SRAM buffer 224. Specifically, in some embodiments, the integrity engine 230) has data path connections to the SRAM buffer 224, which is further connected to the channel controllers 214 via data paths that are controlled by the local memory processor 218. The integrity engine 230 is configured to verify data integrity for each coding block of the memory channels 204.

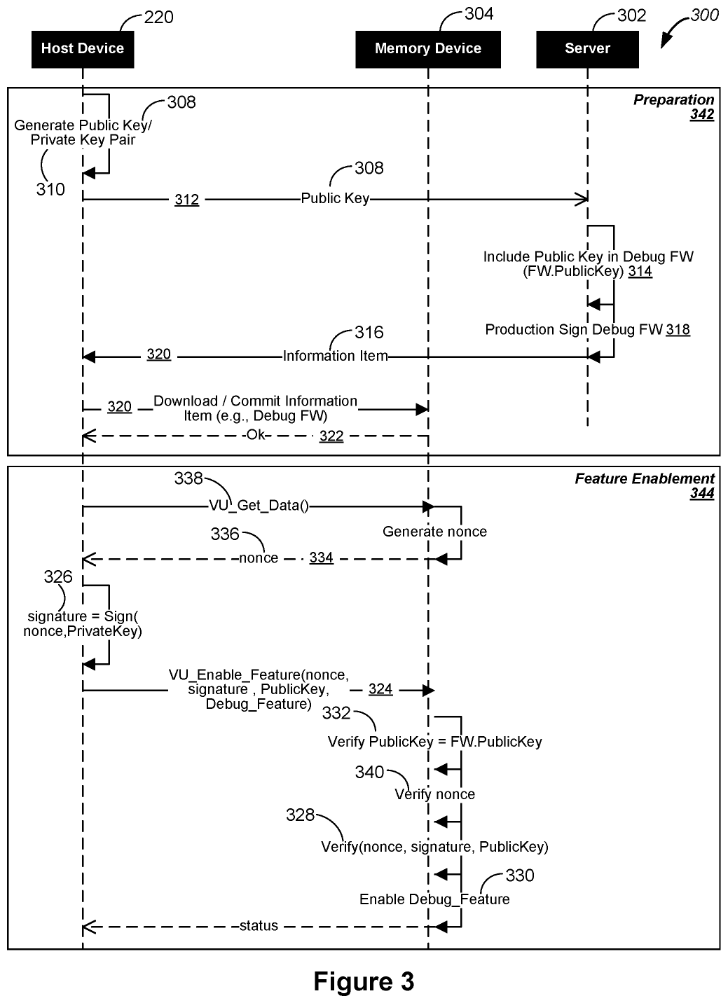

FIG. 3 is a flow diagram of an example secure memory function deployment process 300 implemented among a server 302, a host device 220, and a memory device 304, in accordance with some embodiments. The host device 220 is coupled to a memory system 200 including one or more memory devices 304 (e.g., one or more SSDs) and a controller 202. The controller 202 is configured to receive a memory access request from the host device 220) and access the one or memory devices 304 in response to the request. In some embodiments, the server 302 is associated with a vendor of the memory device 304, and the host device 220 is associated with a customer (i.e., user) who buys the memory device 304 from the vendor. The memory device 304 is disposed in proximity and physically coupled to the host device 220, while the server 302 is located remotely from the host device 220 and memory system 200. The server 302 communicates with the host device 220 and memory system 200 via one or more wireless communication networks. In some embodiments, the memory device 304 obtains (operation 320) an information item 316 (e.g., program codes, user data, signature, public key, and metadata) used to implement a custom memory function (e.g., debugging of a memory error). The memory device 304 receives (operation 324) a host signature 326 and a public key 308 from the host device 220, and authenticates (operation 328) the host signature 326 using the public key 308. In accordance with an authentication of at least the host signature 326, the memory device 304 executes (operation 330) the custom memory function based on the information item 316.

In some embodiments, the host device 220 generates a key pair including the public key 308 and private key 310 associated with the public key 308, and distributes (operation 312) the public key 308 to the server 302, e.g., via one or more communication networks, without involving the memory device 304 coupled to the host device 220. The server 302 associates (operation 314) an information item 316 used to implement a custom memory function with the public key 308. In an example, the information item 316 used to implement the custom memory function includes a debug firmware, e.g., a form of microcode or program to be embedded into the memory device 304 to debug errors in the memory device. In some embodiments, the public key 308 is applied to generate (operation 318) a signature associated with the debug firmware. The information item 316 and/or the signature is provided (operation 320) to the memory device 304 (e.g., via the host device 220). Specifically, in some situation, the host device 220 provides the public key 308 to the server 302, receives the information item 316 with the public key 308 from the server 302, and forward the information item 316 and the public key 308 to be stored as a binary file in a firmware of the memory device 304. Alternatively, in some embodiments, the memory device 304 downloads the information item 316 with the public key 308 and/or associated signature from the server 302 directly. In some embodiments, the memory device 304 sends (operation 322) a confirmation message to the host device 220 after successfully obtaining the information item 316 with the public key 308 and/or the associated signature.

More specifically, in some embodiments, the server 302 generates a signature associated with the public key 308. The information item 316 is concatenated with the signature associated with the public key 308 and sent to the memory device 304 (e.g., via the host device 220). Further, in some embodiments, the server 302 encrypts the information item 316 with the public key 308. The crypted information item 316 is combined with the signature associated with the public key 308 and sent to the memory device 304 (e.g., via the host device 220).

After receiving the information item 316, the memory device 304 further receives (operation 324) a host signature 326 and the public key 308 from the host device 220. The memory device 304 authenticates (operation 328) the host signature 326 using the public key 308. In accordance with an authentication of at least the host signature 326, the memory device 304 executes (operation 330) the custom memory function based on the information item 316. In some embodiments, the information item 316 includes program codes that are executed to implement the custom memory function. Alternatively, in some embodiments, the information item 316 used to implement the custom memory function does not include program codes or software. The custom memory function includes a plurality of features that have been distributed to the memory device 304. The information item 316 sent with the signature includes metadata that provides an additional layer of granularity for enabling the custom memory function. For example, the metadata is provided by the host device 220 and includes an enable signal for one of the plurality of features of the custom memory function. Additionally and alternatively, in some embodiments, a plurality of custom memory functions are deployed to the memory device 304. The memory device 304 receives the information item 316 including a function identifier, and the custom memory function is selected based on the function identifier.

In some embodiments, the information item 316 is associated with the public key 308. The public key 308 is verified (operation 332). The information item 316 is applied to implement the custom memory function in accordance with a verification of the public key 308. In some embodiments, the information item 316 is signed based on the public key 310. From a cryptography perspective, an integrity of the information item 316 is associated with the public key 308 (e.g., by signing and signature verification) during its transmission among the server 302, host device 220, and memory device 304. Encryption and decryption of the information item 316 is required if the information item 316 needs to remain confidential (e.g., if only the server 302 and memory device 304 can see the information item 316).

In some embodiments, the memory device 304 sends (operation 334) a nonce 336 to the host device 220, e.g., in response to a request 338 of the host device 220. The host signature 326 is generated by the host device 220 based on the nonce 336, the private key 310 associated with public key 308, or both. The memory device 304 receives (operation 324) the nonce 336 in addition to the host signature 326 and the public key 308. The nonce 336 is verified (operation 340) separately and with the host signature 326. Both the nonce 336 and the host signature 326 are verified to increase a security level of deployment of the information item 316. In some embodiments, the nonce 336 is an arbitrary number that can be used once in a cryptographic communication. The nonce 336 is optionally a random or pseudo-random number issued in an authentication protocol to ensure that old communications cannot be reused in replay attacks.

In some embodiments, the secure memory function deployment process 300 includes two stages: a preparation stage 342 and a feature enablement stage 344. In the preparation stage 342, the information item 316 and the public key 308 provided by the host device 220 are successfully provided to the server 302, which distributes them back to the memory device 304 associated with the host device 220. In the feature enablement stage 342, the host device 220 provides the public key 308 and the host signature 326 to the memory device 304 separately. The information item 316 is verified if the host signature 326 and/or public key 308 obtained from the host device 220 in the stage 344 are verified with reference to the public key 308 obtained from the server 302 in the stage 342.

This application is directed to secure management of custom memory functions on a memory device 304 coupled to a host device 220 in an electronic system (e.g. a computer system). A PKI is created in the electronic system, allowing asymmetric cryptography to be applied to enable custom memory functions (e.g., certain debug features) in the memory device 304 of the electronic system. Examples of the custom memory function include, but are not limited to, a debugging or experimental function that helps debug a specific memory issue and a specific memory feature to be enabled on mass market memory products (e.g., an SSD manufactured in a selected batch) owned by target customers. The use of asymmetric cryptography enables a secure method for enabling custom memory features and capabilities.

In some embodiments, a host device 220 owned by a customer generates a pair of private key 310 and public key 308 and submits the public key 308 to a server 302 associated with a memory device vendor via a secure communication link. The server 302 incorporates the public key 308 into a firmware release containing a custom memory function. The firmware release is based on previously released production code, and includes the customer public key 308 and an information item 316 (e.g., program code, user data, metadata) associated with a custom memory function requested by the customer. In some embodiments, the public key 308 is optionally built into the firmware, which exposes a provisioning interface that allows provisioning of the public key 308 by the customer after downloading the firmware release. Alternatively, in some embodiments, the firmware release is production code and implemented onto a memory device 304 associated with the host device 220 based on a challenge response protocol (implemented using VU commands). The memory device 304 receives the firmware release, and is required to complete the challenge response protocol before the custom memory function can be implemented on the memory device 304. The challenge response protocol includes a challenge signed by the host device 220. The challenge is previously submitted by the host device 220 to the server 302, and downloaded to the memory device 304 associated with the host device 220. If the memory device 304 (specifically, a memory drive or controller) determines that the challenge was successful, then the custom memory function is executed on the memory device 304. Conversely, if the memory device 304 determines that the challenge is erroneous, the memory device 304 continues to skip the custom memory function and execute existing memory functions. Given that the public key is embedded into the firmware, no one other than the memory device 304 associated with the host device 220 of the target customer is permitted to execute the custom memory function.

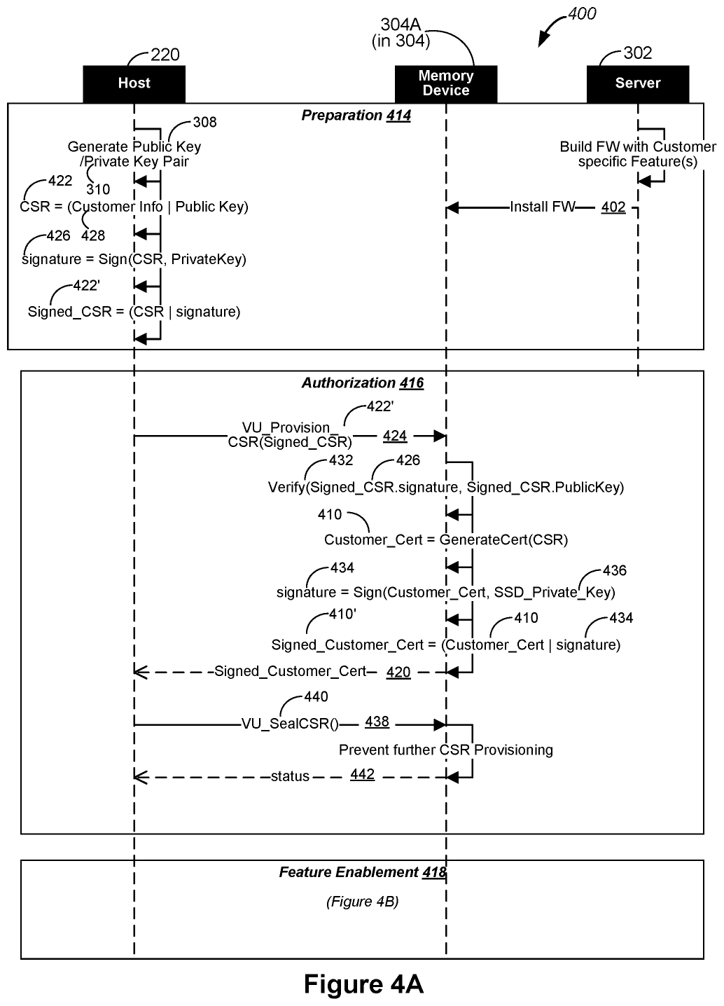

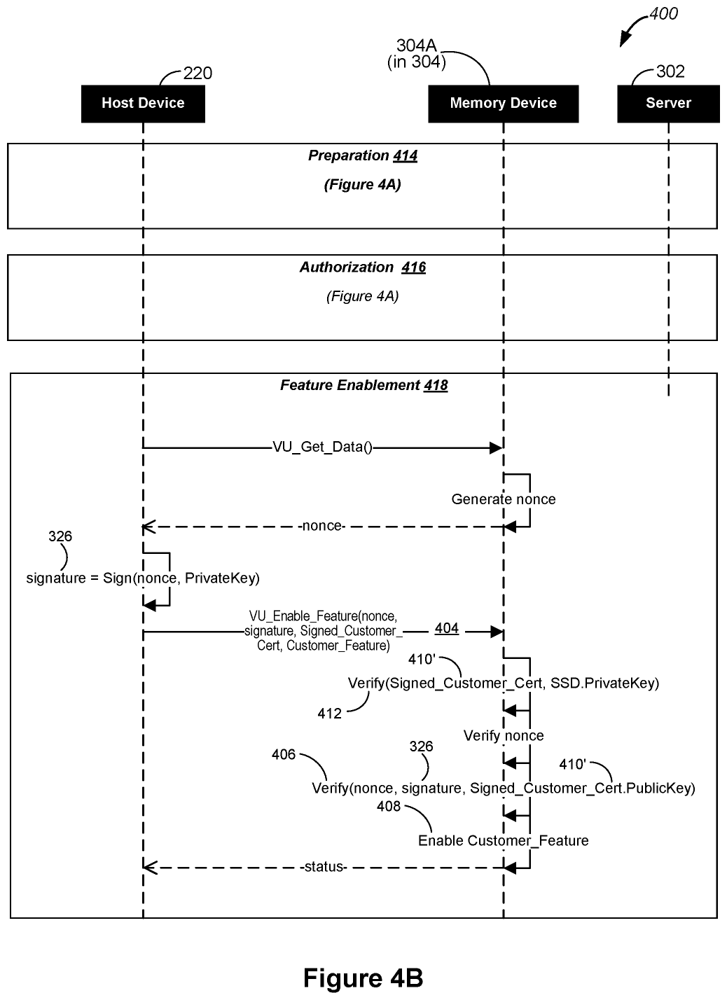

FIGS. 4A-4B are a flow diagram of another secure memory function deployment process 400 implemented among a server 302, a host device 220, and one or more memory devices 304, in accordance with some embodiments. The host device 220 is coupled to a memory system 200 including one or more memory devices 304 (e.g., one or more SSDs) and a controller 202 (FIG. 2). The controller 202 is configured to receive a memory access request from the host device 220 and access the one or memory devices 304 in response to the request. In some embodiments, the server 302 is associated with a vendor of the memory device 304, and the host device 220 is associated with a customer (i.e., user) who buys the memory device(s) 304 from the vendor. The memory device(s) 304 are disposed in proximity and physically coupled to the host device 220 to form a memory system 200, while the server 302 is located remotely from the host device 220 and memory system 200 and communicates with the host device 220 and memory system 200 via one or more wireless communication networks. In some embodiments, the memory device 304 obtains (operation 402, FIG. 4A) an information item 316 used to implement a custom memory function. The memory device 304 receives (operation 404, FIG. 4B) a host signature 326 and a public key 308 from the host device 220, and authenticates (operation 406, FIG. 4B) the host signature 326 using the public key 308. In accordance with an authentication of at least the host signature 326, the memory device 304 executes (operation 408, FIG. 4B) the custom memory function based on the information item 316.

In some embodiments, an information item 316 includes one or more of: program codes, user data, signature, public key, and metadata. In some embodiments, the information item 316 includes a plurality of debugging instructions and associated debugging data, and the custom memory function is implemented to debug an error of the memory device 304 using the plurality of debugging instructions and associated debugging data. Alternatively, in some embodiments, the information item 316 includes a plurality of storage instructions, and the custom memory function includes a custom storage feature associated with the memory device 304. An example of the memory device 304 is an SSD.

The memory device 304 shown in FIGS. 4A and 4B includes a first memory device 304A. The host device 220 is coupled to a plurality of memory devices 304, and a subset of the plurality of memory devices 304 includes the first memory device 304A. The custom memory function is executed at each of the subset of memory devices 304 in accordance with an authentication of at least a respective host signature 326 issued by the host device 220. Additionally, the host device 220 selects the subset of memory devices 304 based on a first-come-first-serve order by obtaining a host identity certificate 410 from each of the subset of memory devices 304. The host identity certificate 410 is authenticated (operation 412), before the memory device 304 executes (operation 408) the custom memory function based on the information item 316.

In some embodiments, the secure memory function deployment process 400 includes three stages: a preparation stage 414, an authorization stage 416, and a feature enablement stage 418. In the preparation stage 414, the information item 316 is provided (operation 402) to the memory device 304 associated with the host device 220. In this example, the information item 316 includes a firmware of customer specific features, and the memory device 304 installs the firmware upon receiving the information item 316. In the authorization stage 416, the host device 220 selects the subset of memory devices 304 for implementing the custom memory function associated with the information item 316. The host device 220 selects the subset of memory devices 304 based on a first-come-first-serve order by obtaining (operation 420) the host identity certificate 410 from each of the subset of memory devices 304. In the feature enablement stage 418, the host signature 326 is provided by the host device 220 to the memory device 304 separately. The information item 316 is verified if the signature 326 and the host identity certificate 410 are verified (operations 406 and 412).

In some embodiments, the memory device 304 includes a first memory device 304A. A set of memory devices 304 is coupled to the host device 220 and includes the first memory device 304A. Each of the set of memory devices 304 (e.g., the first memory device 304A) receives, from the host device 220, a certificate signing request (CSR) 422 for a host identity certificate 410 (customer_cert) issued by the respective memory device 304. The certificate signing request 422 is received (operation 424) with a second host signature 426. In some embodiments, the certificate signing request 422 is generated based on host identification information 428 (e.g., customer_info) and the public key 308, and the second host signature 426 is generated based on the certificate signing request 422 and the private key 310 of the host device 220. In some embodiments, the certificate signing request 422 and the second host signature 426 are concatenated to generate a signed certificate signing request 422′ (e.g., Signed_CSR) and sent (operation 424) to each of the set of memory devices 304. In accordance with a verification 432 of the second host signature 426, the memory device 304 generates the host identity certificate 410 and provide (operation 420) the host identity certificate 410 to the host device 220. During the subsequent feature enablement stage 418, the information item 316 is applied at each of the set of memory devices 304, in accordance with a verification 412 of the host identity certificate 410 provided by the respective memory device 304 to the host device 220.

In some embodiments, the host signature 326 generated during feature enablement stage 418 is a first host signature 326 used for verification of the host identity certificate 410. The second host signature 426 is received with the certificate signing request 422 for generating the host identity certificate 410. During the authorization stage 416, the memory device 304 verifies (operation 432) the second host signature 426 using the public key 308. In accordance with a verification 432 of the second host signature 426, the host identity certificate 410 is generated and provided to the host device 220. Further, in some embodiments, the certificate signing request 422 includes at least information of the host device (e.g., host identification information 428 (customer_info)), and the host identity certificate 410 is generated based on the information of the host device. In some embodiments, the memory device 304 further generates a memory signature 434 based on the host identity certificate 410 and a private key 436 of the memory device 304. The memory device 304 provides, to the host device 220, the memory signature 434 jointly with the host identity certificate 410. In some embodiments, the memory device 304 concatenates the host identity certificate 410 and the memory signature 434 to generate a signed host identity certificate 410′.

In some embodiments, during the authorization stage 416, after providing the host identity certificate 410 to the host device 220, each of the set of memory devices 304 (e.g., the first memory device 304A) receives (operation 438) a certificate estoppel request 440, and confirms (operation 442) that the memory device 304 will not provide any identity certificate or be linked to a distinct electronic system.

It is noted that the host identity certificate 410 is signed with the private key 436 of the memory device 304. When the host identity certificate 410 comes in the feature enablement stage 418, the host identity certificate 410 is signed with the private key 436, thereby enabling the same memory device 304 to verify that the host identity certificate 410 was previously signed (authorized) by the same memory device 304. For clarification, during the feature enablement stage 418, the memory device 304 receives the host identity certificate 410 and the memory signature 434 with the first host signature 326, and verifies the host identity certificate 410 and the memory signature 434 based on the private key 436 of the memory device 304. The information item 316 is applied to implement the custom memory function, in accordance with an authentication 406 of the host signature 326 and a verification 412 of a signed host identity certificate 410′ (e.g., the host identity certificate 410) and the memory signature 434).

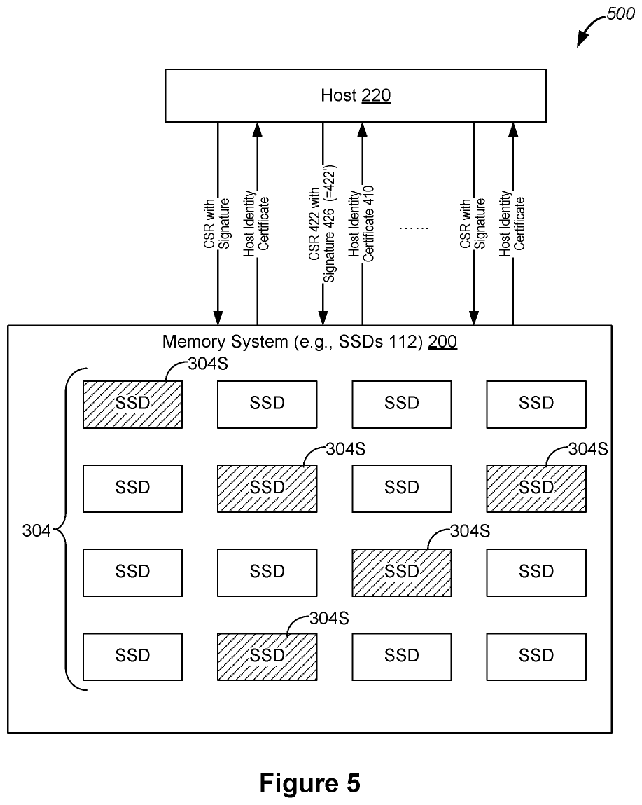

FIG. 5 is a block diagram of an electronic system 500 for deploying a custom memory function to a set of memory devices 304 associated with a host device 220 based on a first-come-first-serve order, in accordance with some embodiments. The host device 220 is coupled to a plurality of memory devices 304 including a subset of memory devices 304S. The custom memory function is executed at each of the subset of memory devices 304 in accordance with an authentication of at least a respective host signature 326 issued by the host device 220. Additionally, the host device 220 selects the subset of memory devices 304S based on a first-come-first-serve order by obtaining a host identity certificate 410 from each of the subset of memory devices 304S.

In some embodiments, the host device 220 is coupled to 32 SSDs, and the server 302 confirms that the host device 220 may enable the custom memory function at 10selected SSDs out of its 32 SSDs, while not specifically identifying the 10 selected SSDs. The 10 SSDs that provide the signed host identity certificate 410′ to the host device 220 first are selected for implementing the custom memory function. After the host device 220 has collected 10 signed host identity certificates 410′ from different memory devices 304, the host device 220 does not collect additional host identity certificates 410′ from remaining 22 SSDs. Each remaining SSD cannot receive the signed host identity certificate 410 from the host device 220 during the feature enablement stage 418, nor does each remaining SSD verify the host identity certificate 410, host signature 326, or both for enabling the custom memory function associated with the information item 316.

More specification, each of the set of memory devices 304S (e.g., the first memory device 304A) receives, from the host device 220, a certificate signing request 422 (signed or not signed) for a host identity certificate 410 (customer_cert) issued by the respective memory device 304S. The certificate signing request 422 is received (operation 424) with a second host signature 426. In some embodiments, the certificate signing request 422 is generated based on host identification information 428 (e.g., customer_info) and the public key 308, and the second host signature 426 is generated based on the certificate signing request 422 and the private key 310 of the host device 220. In some embodiments, the certificate signing request 422 and the second host signature 426 are concatenated to generate a signed certificate signing request 422′ (e.g., Signed_CSR) and sent (operation 424) to each of the set of memory devices 304S. In accordance with a verification 432 of the second host signature 426, the memory device 304S generates the host identity certificate 410 and provide (operation 420, FIG. 4A) the host identity certificate 410 (signed or not signed) to the host device 220.

During the authorization stage 416, the memory device 304S verifies (operation 432, FIG. 4A) the second host signature 426 using the public key 308. In accordance with a verification 432 of the second host signature 426, the host identity certificate 410 is generated and provided to the host device 220. Further, in some embodiments, the certificate signing request 422 includes at least information of the host device (e.g., host identification information 428 (customer_info)), and the host identity certificate 410 is generated based on the information of the host device. In some embodiments, the memory device 304S further generates a memory signature 434 based on the host identity certificate 410 and a private key 436 of the memory device 304S. The memory device 304S provides, to the host device 220, the memory signature 434 jointly with the host identity certificate 410. In some embodiments, the memory device 304S concatenates the host identity certificate 410 and the memory signature 434 to generate a signed host identity certificate 410′. After providing the host identity certificate 410 to the host device 220, each of the set of memory devices 304S (e.g., the first memory device 304A) receives (operation 438, FIG. 4A) a certificate estoppel request 440, and confirms (operation 442, FIG. 4A) that the memory device 304 will not provide any identity certificate or be linked to a distinct electronic system.

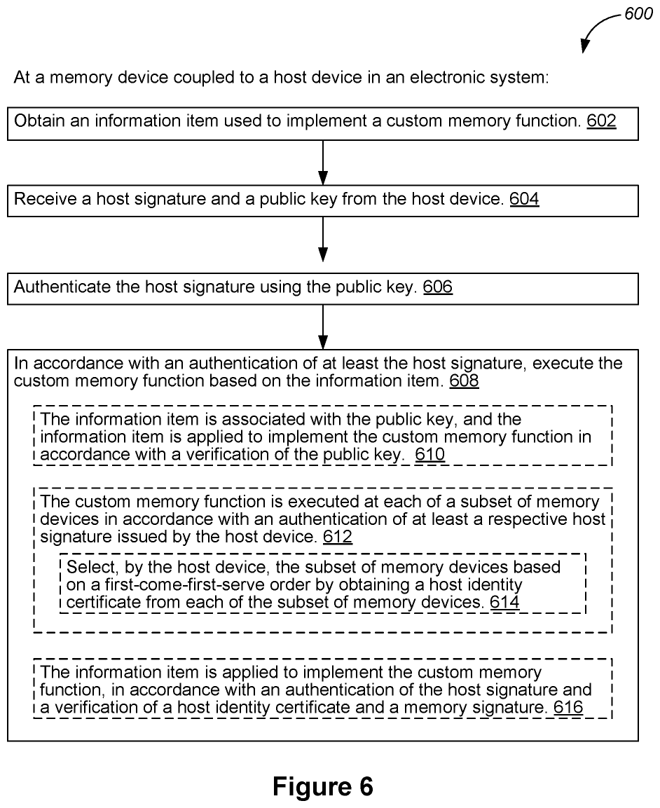

FIG. 6 a flow diagram of an example method 600 for executing a custom memory function securely in an electronic system, in accordance with some embodiments. A memory device 304 is coupled to a host device 220 in the electronic system. The memory device 304 obtains (operation 602) an information item 316 used to implement a custom memory function, receives (operation 604) a host signature 326 and a public key 308 from the host device 220, and authenticates (operation 606) the host signature 326 using the public key 308. In accordance with an authentication of at least the host signature 326, the memory device 304 executes (operation 608) the custom memory function based on the information item 316. Alternatively, from a perspective of the host device 220, the host device 220) generates a key pair including a public key 308 and a private key 310, generates a host signature 326 with the private key 310, sends the host signature 326 and the public key 308 to the memory device 304, and enables the memory device 304 to execute the custom memory function using an information item 316 in accordance with an authentication of at least the host signature 326.

In some embodiments, the information item 316 is associated with the public key 308, and the information item 316 is applied to implement (operation 610) the custom memory function in accordance with a verification of the public key 308. Further, in some embodiments, the memory device 304 obtains the information item 316 by the memory device 304. The host device 220 is configured to provide the public key 308 to a server 302, receive the information item 316 with the public key 308 from the server 302, and forward the information item 316 and the public key 308 to be stored as a binary file in a firmware of the memory device 304. Alternatively, in some embodiments, the memory device 304 downloads the information item 316 with the public key 308 by the memory device 304 from a server 302 directly. The host device 220 is configured to provide the public key 308 to the server 302, and the server 302 is configured to generate the information item 316 using the public key 308.

In some embodiments, the host device 220 generates a key pair including the public key 308 and a private key 310, and generates the host signature 326 based on the private key 310.

In some embodiments, the memory device 304 sends a nonce to the host device 220. The host signature 326 is generated by the host device 220 based on the nonce and a private key 310 associated with public key 308. The memory device 304 receives the nonce in addition to the host signature 326 and public key 308, and the nonce is verified separately and with the host signature 326.

In some embodiments, the memory device 304 receives a function identifier, and selects the custom memory function based on the function identifier, e.g., from a plurality of custom memory functions that are stored locally on the memory device 304.

In some embodiments, the memory device 304 includes a first memory device 304A. The host device 220 is coupled to a plurality of memory devices 304, and a subset of the plurality of memory devices includes the first memory device 304A. The custom memory function is executed (operation 612) at each of the subset of memory devices 304 in accordance with an authentication of at least a respective host signature 326 issued by the host device 220. The host device 220 selects (operation 614) the subset of memory devices based on a first-come-first-serve order by obtaining a host identity certificate 410 from each of the subset of memory devices.

In some embodiments, the memory device 304 includes a first memory device 304A. Each of a set of memory devices 304S is coupled to the host device 220 and includes the first memory device 304A. Each of the set of memory devices 304S receives, from the host device 220, a certificate signing request 422 for a host identity certificate 410 issued by the respective memory device 304A, and receives a second host signature 426 with the certificate signing request 422. In accordance with a verification of the second host signature 426, the memory device 304A generates the host identity certificate 410 and provides the host identity certificate 410 to the host device 220. The information item 316 is applied at each of the set of memory devices 304S, further in accordance with a verification of the host identity certificate 410 provided by the respective memory device 304A to the host device 220).

In some embodiments, the host signature 326 includes a first host signature. The memory device 304 receives, from the host device 220, a certificate signing request 422 for a host identity certificate 410 from the memory device 304. The memory device 304 receives a second host signature 426 with the certificate signing request 422 and verifies the second host signature 426 using the public key 308. In accordance with a verification of the second host signature 426, the memory device 304 verifies the host identity certificate 410 and providing the host identity certificate 410 to the host device 220. Further, in some embodiments, the certificate signing request 422 includes at least information of the host device 220, and the host identity certificate 410 is generated based on the information of the host device 220. In some embodiments, the memory device 304 generates a memory signature 434 (FIG. 4A) based on the host identity certificate 410 and a private key 310 of the memory device 304, and provides, to the host device 220, the memory signature 434 jointly with the host identity certificate 410. Additionally, in some embodiments, the memory device 304 receives the host identity certificate 410 and the memory signature 434 with the first host signature 326 and verifies the host identity certificate 410 and the memory signature 434 based on the private key 436 of the memory device 304. The information item 316 is applied to implement (operation 616) the custom memory function, in accordance with an authentication of the host signature 326 and a verification of the host identity certificate 410 and the memory signature 434. Further, the second host signature 426 is generated based on the certificate signing request 422 and a private key 310 of the host device 220. In some embodiments, after providing the host identity certificate 410 to the host device 220, the memory device 304 receives a certificate estoppel request and confirms that the memory device 304 will not provide any identity certificate or be linked to a distinct electronic system.

In some embodiments, the information item 316 includes a plurality of debugging instructions and associated debugging data, and the custom memory function is implemented to debug an error of the memory device 304 using the plurality of debugging instructions and associated debugging data.

In some embodiments, the information item 316 includes a plurality of storage instructions, and the custom memory function includes a custom storage feature associated with the memory device 304.

This application is directed to secure management of custom memory functions on a memory device 304 coupled to a host device 220 in an electronic system (e.g. a computer system). A PKI is created in the electronic system, allowing asymmetric cryptography to be applied to enable custom memory functions (e.g., certain debug features) in the memory device 304 of the electronic system. Particularly, in some situations, the electronic system deploys a custom memory function to a group of target host devices and their associated memory devices. Examples of the custom memory function include, but are not limited to, a debugging or experimental function that helps debug a specific memory issue and a specific memory feature to be enabled on mass market memory products (e.g., an SSD manufactured in a selected batch) owned by target customers.

The access to the custom memory function is cryptographically limited to one or more targeted customers. The vendor has assurance that other customers will not be permitted to execute the custom memory function. In some embodiments, the number of memory devices that can execute the custom memory function is unlimited, particularly when the host device fully owns a right to enable or disable the custom memory function. Even if the server 302 associated with the vendor accidentally exposes the custom memory function to unintended users who do not know the public key provided by the targeted customers, the memory devices of the unintended users are deterred from executing the custom memory function. The host device has flexibility to either simplify deployment of the custom functionality by using the same public/private key pair across the entire fleet or segment the fleet by creating multiple key pairs for different fleet segments. By these means, a server 302 associated with a vendor can deploy custom memory functions to target host devices and associated memory devices (e.g., SSDs associated with individual or data center host devices) securely without non-disclosure agreements.

In some embodiments, each of the server 302, host device, and memory device possesses cryptographic capabilities including one or more of: digital certificate generation (e.g., under X.509), asymmetric key pair generation (e.g., using RSA or ECDSA), key wrapping and unwrapping (e.g., using NIST SP600-38F), deterministic random bit generation (e.g., under NIST SP600-90A, 90B, 90C), and digital signature verification (e.g., under FIPS 186-4). Provisioning of a public key occurs in a secure environment. For example, the public key is generated in the host device at a secure location within a customer premise, and transmitted to the server 302 associated with a vendor via a secure transfer before it is incorporated into a firmware release.

Memory is also used to store instructions and data associated with the method 600, and includes high-speed random-access memory, such as DRAM, SRAM, DDR RAM, or other random access solid state memory devices: and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 600.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if”' is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method, comprising:
at a memory device coupled to a host device in an electronic system:
obtaining an information item used to implement a custom memory function;
receiving a host signature and a public key from the host device;
authenticating the host signature using the public key; and
in accordance with an authentication of at least the host signature, executing the custom memory function based on the information item.

2. The method of claim 1, wherein the information item is associated with the public key, and the information item is applied to implement the custom memory function in accordance with a verification of the public key.

3. The method of claim 2, further comprising:
obtaining the information item by the memory device, wherein the host device is configured to provide the public key to a server, receive the information item with the public key from the server, and forward the information item and the public key to be stored as a binary file in a firmware of the memory device.

4. The method of claim 2, further comprising:
downloaded the information item with the public key by the memory device from a server directly, wherein the host device is configured to provide the public key to the server, and the server is configured to generate the information item using the public key.

5. The method of claim 1, further comprising, at the host device:
generating a key pair including the public key and a private key; and
generating the host signature based on the private key.

6. The method of claim 1, further comprising at the memory device:
sending a nonce to the host device, wherein the host signature is generated by the host device based on the nonce and a private key associated with public key; and
receiving the nonce in addition to the host signature and public key, wherein the nonce is verified separately and with the host signature.

7. The method of claim 1, wherein:
the memory device includes a first memory device;
the host device is coupled to a plurality of memory devices, and a subset of the plurality of memory devices includes the first memory device:
the custom memory function is executed at each of the subset of memory devices in accordance with an authentication of at least a respective host signature issued by the host device; and
the method further comprises selecting, by the host device, the subset of memory devices based on a first-come-first-serve order by obtaining a host identity certificate from each of the subset of memory devices.

8. The method of claim 1, the host signature including a first host signature, the method further comprising at the memory device:
receiving, from the host device, a certificate signing request for a host identity certificate issued by the memory device:
receiving a second host signature with the certificate signing request;
verifying the second host signature using the public key; and
in accordance with a verification of the second host signature, generating the host identity certificate and providing the host identity certificate to the host device.

9. The method of claim 8, wherein the certificate signing request includes at least information of the host device, and the host identity certificate is generated based on the information of the host device.

10. The method of claim 8, further comprising:
generating a memory signature based on the host identity certificate and a private key of the memory device; and
providing, to the host device, the memory signature jointly with the host identity certificate.

11. The method of claim 10, further comprising:
receiving the host identity certificate and the memory signature with the first host signature; and
verifying the host identity certificate and the memory signature based on the private key of the memory device;
wherein the information item is applied to implement the custom memory function, in accordance with an authentication of the host signature and a verification of the host identity certificate and the memory signature.

12. An electronic system, comprising:
one or more processors: and
memory storing one or more programs for execution by the one or more processors, the one or more programs comprising instructions for, at a memory device coupled to a host device in the electronic system:
obtaining an information item used to implement a custom memory function;
receiving a host signature and a public key from the host device;
authenticating the host signature using the public key; and
in accordance with an authentication of at least the host signature, executing the custom memory function based on the information item.

13. The electronic system of claim 12, the host signature including a first host signature, the one or more programs further comprising instructions for, at the memory device:
receiving, from the host device, a certificate signing request for a host identity certificate from the memory device;
receiving a second host signature with the certificate signing request;
verifying the second host signature using the public key; and
in accordance with a verification of the second host signature, generating the host identity certificate and providing the host identity certificate to the host device.

14. The electronic system of claim 13, wherein the second host signature is generated based on the certificate signing request and a private key of the host device.

15. The electronic system of claim 13, further comprising, after providing the host identity certificate to the host device:
receiving a certificate estoppel request; and confirming that the memory device will not provide any identity certificate or be linked to a distinct electronic system.

16. The electronic system of claim 12, wherein the information item includes a plurality of debugging instructions and associated debugging data, and the custom memory function is implemented to debug an error of the memory device using the plurality of debugging instructions and associated debugging data.

17. A non-transitory computer-readable storage medium, storing one or more programs for execution by one or more processors, the one or more programs further comprising instructions for, at a memory device coupled to a host device in an electronic system:
obtaining an information item used to implement a custom memory function;
receiving a host signature and a public key from the host device;
authenticating the host signature using the public key; and
in accordance with an authentication of at least the host signature, executing the custom memory function based on the information item.

18. The non-transitory computer-readable storage medium of claim 17, wherein the information item includes a plurality of storage instructions, and the custom memory function includes a custom storage feature associated with the memory device.

19. The non-transitory computer-readable storage medium of claim 17, wherein the memory device includes a first memory device, the one or more programs further comprising instructions for, at each of a set of memory devices coupled to the host device and including the first memory device:
receiving, from the host device, a certificate signing request for a host identity certificate issued by the respective memory device;
receiving a second host signature with the certificate signing request;
in accordance with a verification of the second host signature, generating the host identity certificate and providing the host identity certificate to the host device;
wherein the information item is applied at each of the set of memory devices, further in accordance with a verification of the host identity certificate provided by the respective memory device to the host device.

20. The non-transitory computer-readable storage medium of claim 17, the one or more programs further comprising instructions for, at the memory device:
receiving a function identifier; and
selecting the custom memory function based on the function identifier.
